(19) United States
(12) Patent Application Publication
(10) Pub. No.: US 2025/0378102 A1
(43) Pub. Date: Dec. 11, 2025

(54) PERFORMING FACT CHECKING USING MACHINE LEARNING MODELS

(71) Applicant: X Development LLC, Mountain View, CA (US)

(72) Inventors: Ozan Gokdemir, Chicago, IL (US); Garrett Raymond Honke, Mountain View, CA (US); Jeffrey Bush, Los Altos, CA (US)

(21) Appl. No.: 18/737,572

(22) Filed: Jun. 7, 2024

(51) Int. Cl. G06F 16/35; G06F 16/338; G06F 40/30

(52) U.S. Cl. CPC G06F 16/35; G06F 16/338; G06F 40/30

(57) ABSTRACT

Methods, systems, and apparatus, including computer programs encoded on computer storage media, for performing tasks. One of the methods includes receiving a trigger from a user; responsive to the trigger, obtaining text data representing one or more subwords to be processed; obtaining data representing a plurality of clusters, wherein each cluster comprises one or more documents of a plurality of documents; processing the text data to identify one or more clusters of the plurality of clusters that are relevant to the text data; for each of the one or more identified clusters: identifying one or more documents of the identified cluster that are relevant to the text data; identifying one or more documents that contradict the text data of the one or more identified documents that are relevant to the text data; and providing data representing the one or more identified documents that contradict the text data.

### BACKGROUND

This specification relates to processing data using machine learning models.

Machine learning models receive an input and generate an output, e.g., a predicted output, based on the received input. Some machine learning models are parametric models and generate the output based on the received input and based on values of the parameters of the model.

Some machine learning models are deep models that employ multiple layers to generate an output for a received input. For example, a deep neural network is a deep machine learning model that includes an output layer and one or more hidden layers that each apply a non-linear transformation to a received input to generate an output.

### SUMMARY

This specification describes a system implemented as computer programs on one or more computers in one or more locations for performing fact checking on text data. For example, the system can identify documents that contradict text data, e.g., deposition transcript data, using one or more machine learning models.

In general, one innovative aspect of the subject matter described in this specification can be embodied in methods that include the actions of receiving a trigger from a user; responsive to the trigger, obtaining text data representing one or more subwords to be processed; obtaining data representing a plurality of clusters, wherein each cluster comprises one or more documents of a plurality of documents; processing the text data to identify one or more clusters of the plurality of clusters that are relevant to the text data; for each of the one or more identified clusters: identifying one or more documents of the identified cluster that are relevant to the text data; identifying one or more documents that contradict the text data of the one or more identified documents that are relevant to the text data; and providing data representing the one or more identified documents that contradict the text data.

Other embodiments of this aspect include corresponding computer systems, apparatus, and computer programs recorded on one or more computer storage devices, each configured to perform the actions of the methods. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

The foregoing and other embodiments can each optionally include one or more of the following features, alone or in combination. In particular, one embodiment includes all the following features in combination.

In some implementations, the method further includes identifying one or more statements that contradict the text data of the one or more identified documents that contradict the text data; and providing data representing the one or more identified statements to the user.

In some implementations, obtaining text data comprises obtaining the text data from a transcript of speech.

In some implementations, obtaining text data comprises: obtaining a plurality of sentences from a sequence of text, wherein each sentence is associated with a timestamp; and assigning a set of one or more sentences from the plurality of sentences as the text data, wherein each sentence in the set of one or more sentences is associated with a timestamp prior to a time that the trigger from the user was received.

In some implementations, obtaining text data comprises: obtaining a plurality of segments from a sequence of text, wherein each segment comprises a plurality of subwords that are semantically relevant, and wherein each segment is associated with a timestamp; and assigning a particular segment from the plurality of segments as the text data, wherein the particular segment is associated with a timestamp prior to a time that the trigger from the user was received.

In some implementations, each cluster is associated with a summary for the cluster, and wherein obtaining data representing a plurality of clusters comprises generating the data representing the plurality of clusters, and wherein generating the data representing the plurality of clusters comprises: obtaining document data representing one or more documents; generating a respective document embedding for each of the one or more documents; clustering the respective document embeddings for the one or more documents into a plurality of clusters; and for each of the plurality of clusters, generating the associated summary for the cluster.

In some implementations, clustering the respective document embeddings comprises clustering using hierarchical agglomerative clustering.

In some implementations, clustering the respective document embeddings comprises clustering using nearest neighbor clustering.

In some implementations, generating the associated summary for the cluster comprises providing the documents for the cluster to a machine learning model that is configured to generate a summary for input documents, wherein the summary comprises one or more facts in the input documents.

In some implementations, each cluster is associated with a summary for the cluster, and wherein processing the text data to identify one or more clusters of the plurality of clusters that are relevant to the text data comprises: generating an embedded representation for the text data; obtaining a respective embedding for each summary of each cluster; for each respective embedding for each summary: determining a similarity between the respective embedding and the embedded representation for the text data; determining that the similarity meets a threshold similarity; and in response, identifying the cluster for the respective embedding as relevant to the text data.

In some implementations, each of the documents of the plurality of documents includes metadata, and wherein the metadata comprises attribute values for one or more attributes, and wherein obtaining a respective embedding for each summary of each cluster comprises: filtering the plurality of clusters to identify one or more qualifying clusters having documents that include attribute values matching particular criteria, wherein the particular criteria defines one or more attribute values for the one or more attributes; and obtaining a respective embedding for each summary of each qualifying cluster of the one or more qualifying clusters.

In some implementations, the particular criteria is defined by the user.

In some implementations, identifying one or more documents of the identified cluster that are relevant to the text data comprises: for each document of the identified cluster: determining a document similarity between an embedded representation of the document and an embedded representation of the text data; determining that the document similarity meets a document threshold similarity; and in response, identifying the document as relevant to the text data.

In some implementations, identifying one or more documents that contradict the text data of the one or more identified documents that are relevant to the text data comprises: for each document of the identified documents that are relevant to the text data: determining a contradiction score between the document and the text data using a machine learning model; determining that the contradiction score meets a threshold contradiction score; and in response, identifying the document as contradicting the text data.

In some implementations, the machine learning model is a large language model.

In some implementations, the machine learning model is configured to generate a contradiction score representing a likelihood that two input sequences of text negate each other.

In some implementations, identifying one or more documents that contradict the text data of the one or more identified documents that are relevant to the text data comprises: providing an input prompt comprising at least the text data and one or more documents of the identified documents that are relevant to the text data to a language model to generate an output indicating whether the text data contradicts the one or more documents of the input prompt; and identifying one or more documents of the input prompt as contradicting the text data based on the output.

In some implementations, identifying one or more statements that contradict the text data of the one or more identified documents that contradict the text data comprises: providing an input prompt comprising at least the text data and the one or more identified documents to a language model to generate an output indicating which statements of the one or more identified documents contradict the text data; and identifying one or more statements of the one or more identified documents as contradicting the text data based on the output.

Particular embodiments of the subject matter described in this specification can be implemented to realize one or more of the following advantages.

The system described in this specification can identify documents and statements from a given set of documents that contradict given text data within limited time constraints (e.g., in less than 1 hour, in less than 30 minutes, in less than 10 minutes, in less than 5 minutes, in less than 3 minutes, or in less than 1 minute after receiving the given text data depending on a variety of factors such as the computing resources being used, the number and size of documents in the set of documents, and the amount of parallelization, such as the number of parallel threads processing the documents). The given text data can include a statement from a speaker of interest, such as a deponent during a live deposition. The given set of documents can include documents relevant to the case of the deposition, such as communication records and business records produced during discovery.

Conventionally, determining contradicting documents and statements may require manually searching through documents, which may consume a large amount of time and resources. The amount of text or the number of documents may be extremely large. For example, a discovery process may involve hundreds, thousands, or tens of thousands of documents. The discovery process may involve more than a thousand words, more than ten thousand words, more than one hundred thousand words, more than one million words or more than 10 million words. The system described in this specification can provide data representing contradicting documents and statements over a large number of documents within a limited time constraint, such as during a live deposition. The system can determine contradictions or discrepancies between a given statement and the content of the documents, within time constraints that allow a user to use the contradictions or discrepancies determined by the system. For example, the user can point out issues in the deponent's testimony such as that the deponent is lying or withholding facts.

Prior to a deposition, the system can encode a set of documents pertinent to the case into a mathematical vector representation using a large language model (LLM). This representation, also called an embedding, can allow for clustering documents based on their semantic relevance as measured by the mathematical distance between their embeddings. Each cluster includes one or more documents.

To identify documents and statements from a given set of documents that contradict given text data, the system can receive text data representing the statement to be processed. During the deposition, the system obtains text data representing the statement to be processed, such as a statement by a deponent. The system then leverages the same large language model or a separate large language model to encode the text data into an embedding whose format is consistent with those of the document embeddings. The embedding of the deponent statement can then be utilized to search for documents that might contain facts that contradict the deponent statement. For example, the system can process the text data to identify clusters that are relevant to the text data. For each of the identified clusters, the system can identify documents of the identified cluster that are relevant to the text data. The system can identify documents that contradict the text data from the documents that are relevant to the text data, for example, using the large language model. The system can provide data representing the contradicting documents to the user.

Multiple optimizations allow for the execution of this search operation simultaneously with the ongoing deposition. First, the system executes the search in a mathematical landscape called latent space in which semantic proximity of two arbitrary documents are given by the mathematical distance functions of their embeddings, e.g., Euclidean distance or cosine similarity. The system can use modern computer hardware such as Graphics Processing Units (GPUs), which are highly optimized to streamline the computation of these functions, improving the average response time of the system. In addition, the system implements a hierarchical search algorithm which performs the search only among a subset (cluster) of documents whose embeddings are within a mathematical proximity to that of the deponent statement, pruning the search space and mitigating overhead. Furthermore, the system performs the search in parallel by an arbitrary number of computer processes among which the documents to be searched can be distributed. For example, the documents can be distributed evenly among the computer processes.

The system can provide for parallelization, decreasing the computing time for identifying contradicting documents and statements. For example, the system can process multiple relevant documents to identify contradicting documents from relevant documents in parallel. For example, the system can include multiple instances of an LLM. The system can provide different input prompts to each instance. The different input prompts can include different sets or batches of relevant documents.

The system can provide for computationally efficient storage and retrieval of documents and clusters. For example, the system can store data representing documents, document identifiers, and embedded documents. An embedded document can be a representation of a document in the form of embeddings. The system can store data representing clusters as sets or lists of document identifiers, rather than storing data representing clusters as sets of documents. The system thus can reduce the storage requirements for storing data representing clusters. In addition, when identifying relevant documents, the system can use the embedded documents, rather than the content of each document, reducing the computing time for identifying relevant documents and for retrieving the content of each document.

In some implementations, the system can provide for determining contradicting statements and documents to a given statement along with context. For example, the context can include a name or a time. The context can be provided by the user, for example. The system can thus provide contradicting documents and statements that may be more focused to the information for which the user is looking.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 shows an example system for performing fact checking.

FIG. 2 shows an example process for performing fact checking.

FIG. 3 is a flow chart of an example process for performing fact checking.

FIG. 4 is a flow chart of another example process for performing fact checking.

FIG. 5 is an example user interface for interaction with an example system for performing fact checking.

FIG. 6 depicts a schematic diagram of a computer system that may be applied to any of the computer-implemented methods and other techniques described herein.

Like reference numbers and designations in the various drawings indicate like elements.

### DETAILED DESCRIPTION

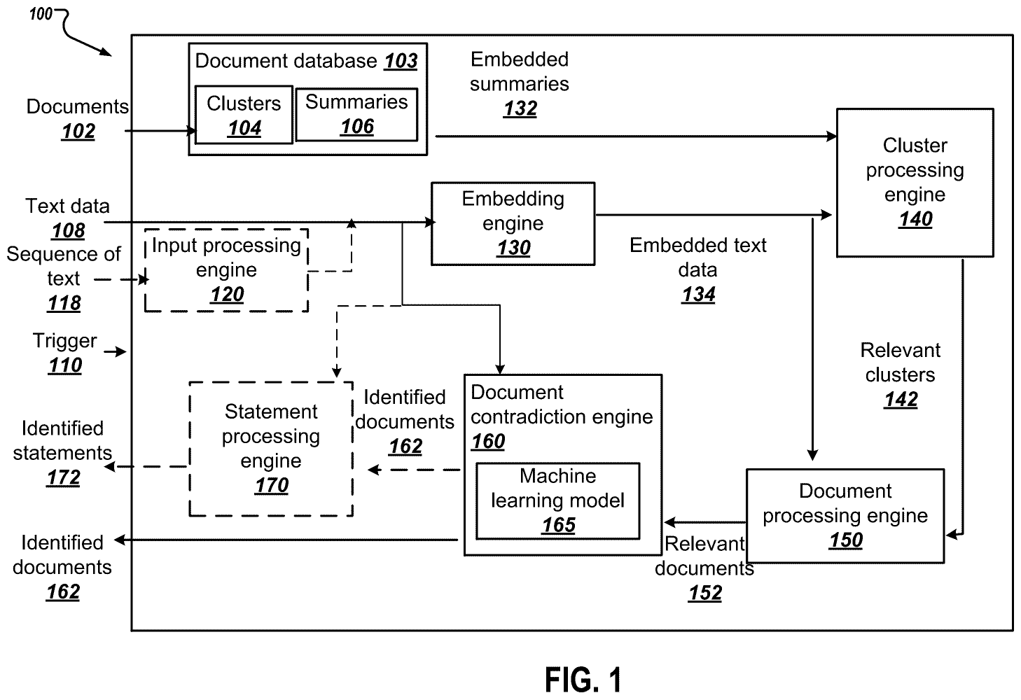

FIG. 1 shows an example system 100 for performing fact checking. The system 100 is an example of a system implemented as computer programs on one or more computers in one or more locations. The system 100 can include a document database 103, an embedding engine 130, a cluster processing engine 140, a document processing engine 150, a document contradiction engine 160, and optionally, an input processing engine 120 and a statement processing engine 170. In some implementations, the components can be part of a same system and/or network of computing devices and/or systems. Although this specification can be applied to documents and text data that are relevant to a deposition, the system 100 can be used to perform fact checking for many types of documents such as Internet webpages, and for many types of text data such as speeches or social media comments.

The document database 103 can be any appropriate computing system that is configured to store data representing clusters 104 and summaries 106. Each cluster of clusters 104 can include one or more documents from the documents 102 that are similar to each other. Each summary in summaries 106 can be a natural language summary of the documents for a particular cluster in clusters 104. For example, the system 100 can generate the data representing clusters 104 and summaries 106 from documents 102 using an embedding engine such as the embedding engine 130 and machine learning models such as the machine learning models 165. In some implementations, data representing summaries 106 can include embedded representations of the summaries, embedded summaries 132.

In some implementations, the document database 103 can store the documents 102 and a mapping of document identifiers for each of the documents 102. The system 100 can use the document identifiers to retrieve the content of documents 102. In some implementations, each cluster of clusters 104 can include a set or list of document identifiers for each of the documents of the cluster.

The documents 102 can include one or more documents that each include one or more statements that each include one or more subwords. For example, the one or more documents can include communication records such as e-mails, letters, or transcripts. The documents can also include records such as contracts.

The embedding engine 130 can be any appropriate computing system that is configured to generate embeddings of data such as text. For example, the embedding engine 130 can generate embeddings of the text data 108. An “embedding,” as used in this specification is a vector of numeric values, e.g., floating point or other type of numeric values, that has a predetermined dimensionality, e.g., has a predetermined number of values. In some implementations, the embedding engine 130 can be finetuned on training data for a particular domain, such as the legal domain. For example, the embedding engine 130 can be an encoder neural network or a large language model such as Gemini, Gemma, or PaLM.

The text data 108 can include text data that represents one or more subwords. For example, the one or more subwords can be part of a statement made by a deponent during a deposition. In some examples, the one or more subwords can also represent a context for the statement. For example, the context can identify a speaker of the statement.

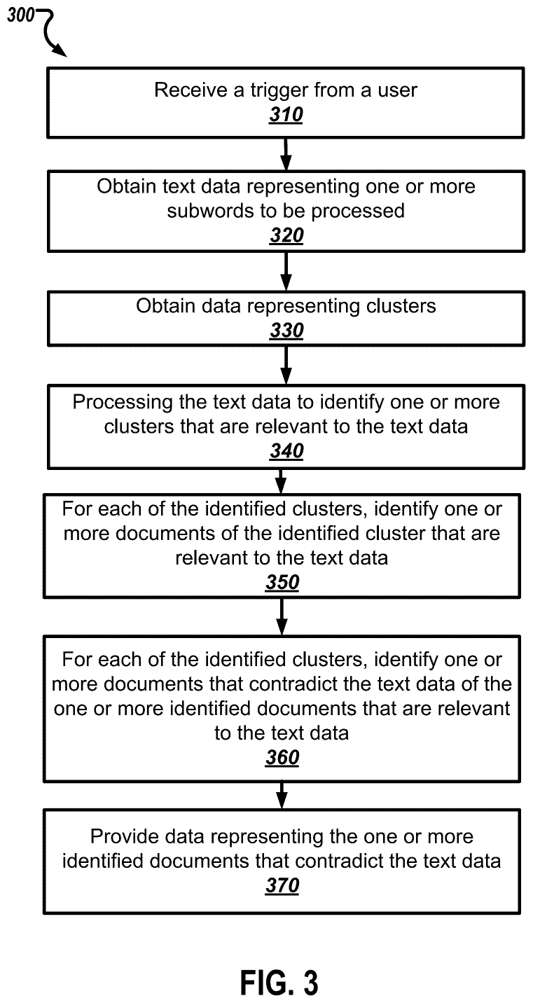

In some implementations, the system 100 can obtain the text data 108 using the input processing engine 120. For example, the system 100 can obtain the text data 108 from a sequence of text 118, such as a transcript of speech. For example, the sequence of text 118 can include a continuously updated transcript of speech during a live deposition. The system can use the input processing engine 120 to determine a portion of a text string, e.g., a portion of a transcript, to process based on the trigger. The input processing engine 120 can assign the text data 108 to include a subset of the transcript of speech. For example, the input processing engine 120 can process the sequence of text 118 to determine a set of one or more sentences, or a particular segment of text, within the sequence of text 118 with a timestamp that is prior to, or concurrent with, the receipt of the trigger 110. Obtaining text data 108 from a sequence of text 118 is described in further detail below with reference to FIG. 3.

The cluster processing engine 140 can be any appropriate computing system that is configured to identify clusters relevant to given text data. For example, the cluster processing engine 140 can process embedded summaries 132 and embedded text data 134 to determine a similarity between each embedded summary and the embedded text data 134, and output relevant clusters 142. For example, the similarity can represent a similarity in vector space of an embedded summary and the embedded text data 134. As an example, cluster processing engine 140 can output relevant clusters 142 as the clusters for which the similarity between the corresponding embedded summary and the embedded text data 134 meets a threshold similarity.

The document processing engine 150 can be any appropriate computing system that is configured to identify documents relevant to given text data and documents that contradict given text data. For example, the document processing engine 150 can receive the relevant clusters 142 and the embedded text data 134. The document processing engine 150 can obtain the documents of each of the relevant clusters 142. For example, the document processing engine 150 can obtain embedded representations of each of the documents. The document processing engine 150 can determine a similarity between the embedded representations of each of the documents and the embedded text data 134. For example, the similarity can represent a similarity in vector space of an embedded representation of a document and the embedded text data 134.

As an example, the document processing engine 150 can output relevant documents 152 as the documents for which the similarity between the embedded representation of the document and the embedded text data 134 meets a threshold similarity. In some implementations, the document processing engine 150 can use a machine learning model to determine the similarity.

The machine learning model can be configured to determine a similarity between two input sequences of text. For example, the machine learning model can be configured to determine a similarity score between an embedded representation of a document and the embedded text data 134. As another example, the machine learning model can be a large language model that is configured to determine a similarity score between a document and text data 108.

The document contradiction engine 160 can be any appropriate computing system that is configured to identify documents that contradict given text data. For example, the document contradiction engine 160 can receive the relevant documents 152 and the text data 108. The document contradiction engine 160 can use a machine learning model 165 to identify documents 162 that contradict given text data. For example, the machine learning model 165 can be a large language model such as Gemini, Gemma, or PaLM. The machine learning model 165 can be a Transformer-based model.

The document contradiction engine 160 can generate a prompt for each document in relevant documents 152 to provide as input to the machine learning model 165. For example, the machine learning model 165 can receive a prompt that includes a document (selected from relevant documents 152), the text data 108, and a query about whether the document includes statements that contradict the text data 108. The machine learning model 165 can output an answer to the query, for example, an affirmative or a negative answer. In some examples, the prompt can include a query about the number of statements in the document that contradict the text data 108. The machine learning model 165 can output an answer to the query that includes a number of statements in the document that contradict the text data 108. In some examples, the prompt can include a query about statements in the document that contradict the text data 108. The machine learning model 165 can output an answer to the query that includes data representing the statements in the document that contradict the text data 108.

In some examples, the prompt can include a query about documents and/or statements that contradict the text data 108 to a degree that meets a threshold level of contradiction. The machine learning model 165 can output an answer to the query, for example, documents and/or statements that contradict the text data 108 and an indication of the degree that they contradict the text data 108. In some examples, the prompt can include a query about documents and/or statements that contradict the text data 108, and a request to explain why the documents and/or statements contradict the text data 108. The machine learning model 165 can output an answer to the query, for example, documents and/or statements that contradict the text data 108 and explanations for why they contradict the text data 108.

The document contradiction engine 160 can process the output of the machine learning model 165 to identify whether a document contradicts the text data 108. For example, if the machine learning model 165 outputs an affirmative answer for a particular document, the document contradiction engine 160 can identify the particular document as contradicting the text data 108. As another example, if the machine learning model 165 outputs a non-zero number of statements that contradict the text data 108 for a particular document, the document contradiction engine 160 can identify the particular document as contradicting the text data 108. As another example, if the machine learning model 165 outputs data representing statements that contradict the text data 108 for a particular document, the document contradiction engine 160 can identify the particular document as contradicting the text data 108. The document contradiction engine 160 can output the identified documents 162.

As an example, to provide identified documents 162, the system 100 can receive the trigger 110. The trigger 110 can represent an input from the user that indicates the user would like to perform fact checking for text data 108. The trigger 110 can also represent an input from the user that indicates the user would like to perform fact checking on text data 108 that has recently been spoken.

The system 100 can obtain text data 108. The system 100 can use the embedding engine 130 to generate embedded text data 134 from the text data 108. The system can obtain embedded summaries 132 from the clusters 104 and summaries 106 in the document database 103. In some examples, the system can have generated the clusters 104 and summaries 106 from documents 102.

The system can provide the embedded summaries 132 and the embedded text data 134 to the cluster processing engine 140. The cluster processing engine 140 can determine relevant clusters 142. The system can provide the embedded text data 134 and the relevant clusters 142 to the document processing engine 150. The document processing engine 150 can determine relevant documents 152 from each of the relevant clusters 142. The system can provide the relevant documents 152 to the document contradiction engine 160. The document contradiction engine 160 can identify documents 162 that contradict the text data 108 from the relevant documents 152 as described above. The system 100 can output the identified documents 162.

In some implementations, the system 100 can identify statements 172 that contradict the text data 108. In some examples, the document contradiction engine 160 can receive data representing statements that contradict the text data 108 for a particular document from machine learning model 165. The document contradiction engine 160 can identify the particular document as contradicting the text data 108, and can also identify the statements as identified statements 172 that contradict the text data 108. The document contradiction engine 160 can output identified statements 172 that include any statements that contradict the text data 108 for all of the relevant documents 152.

In some examples, the system 100 can also include a statement processing engine 170. The statement processing engine 170 can be any appropriate computing system that is configured to identify statements that contradict given text data. For example, the statement processing engine 170 can process the text data 108 and the identified documents 162 to generate identified statements 172.

For example, the statement processing engine 170 can use a machine learning model such as the machine learning model 165 to generate identified statements 172. The statement processing engine 170 can generate a prompt for each document in identified documents 162 and provide the prompt as input to the machine learning model. For example, the prompt can include a document of identified documents 162, the text data 108, and a query about statements in the document that contradict the text data 108. The machine learning model can output an answer to the query that includes data representing the statements in the document that contradict the text data 108. The statement processing engine 170 can output the identified statements 172. The machine learning model can be a large language model such as Google's Language Model for Dialogue Applications (LaMDA). In some examples, the system can interact with LaMDA using an interface such as Bard, a conversational AI service.

In some implementations, the system 100 can obtain a subset of embedded summaries 132 from the document database 103. For example, each of the documents of the document database 103 can include metadata that includes attribute values for one or more attributes. For example, the attributes can include features of the content of the document, such as speaker, author, time, etc. The attribute values can include names, titles, or dates. The system 100 can filter the clusters 104 to identify a subset of clusters that include documents with attribute values that match particular criteria. The particular criteria can define attribute values for the one or more attributes. In some examples, the particular criteria can be defined by the user. The system can thus obtain an embedded summary of each cluster in the identified subset of clusters.

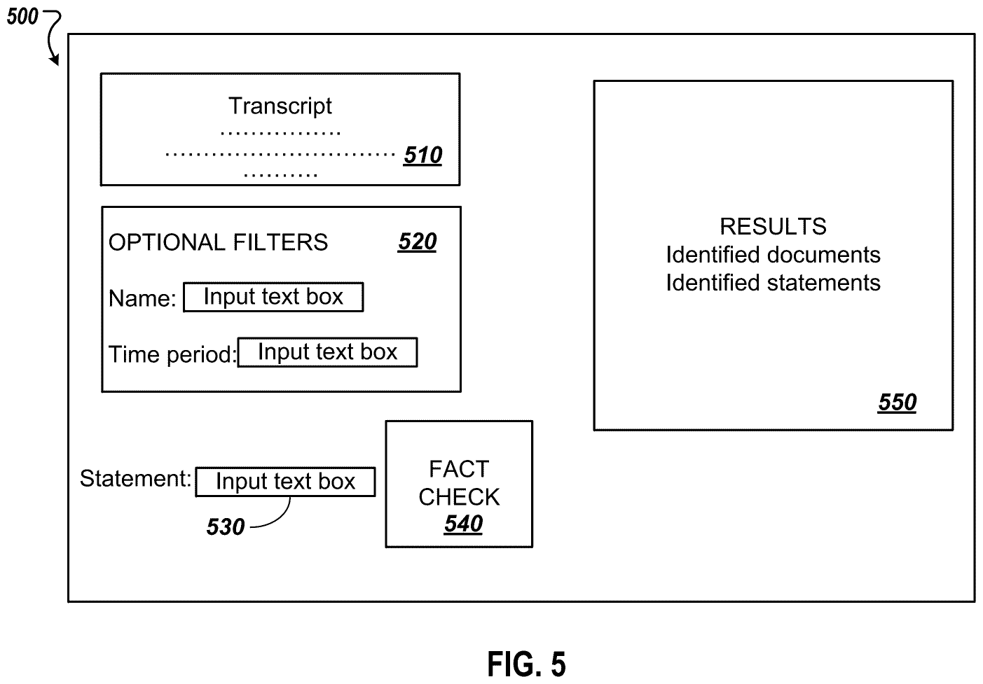

In some implementations, the system 100 can include a user interface. The user interface can be configured to allow a user to interact with the system 100. For example, the user interface can allow a user to input text data 108 and receive identified documents 162 and/or identified statements 172 from the system 100. The user interface can also allow a user to input a trigger 110 and documents 102. An example user interface is described below with reference to FIG. 5.

In some implementations, the system 100 can output the identified documents 162 and/or the identified statements 172 in the context of the documents 102. For example, the system 100 can provide an identified document from documents 102 for display to the user, with the identified statements 172 for the identified document highlighted.

In some implementations, the system 100 can provide a natural language summary, e.g., from a large language model, of the contradiction between the identified document(s) and/or identified statement(s) and the text data 108. In some implementations, the system 100 can provide a location of each of the identified documents and/or identified statements, e.g., a file location, a file name, or a paragraph number or line number within a document.

In some implementations, the system 100 can provide explanations, e.g., from a large language model, of the contradiction between the identified document(s) and/or identified statement(s) and the text data 108. In some implementations, the system 100 can provide labels, e.g., from a large language model, of the type or degree of contradiction between the identified document(s) and/or identified statement(s) and the text data 108.

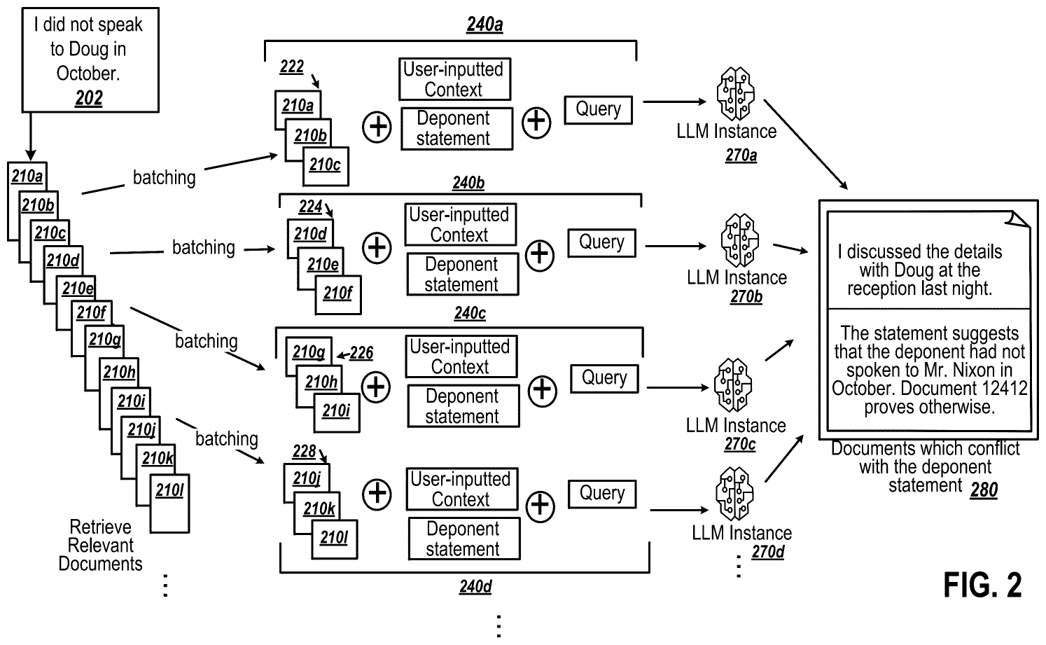

FIG. 2 shows an example process 200 for performing fact checking. For convenience, the process 200 will be described as being performed by a system of one or more computers located in one or more locations. For example, a system for performing fact checking, e.g., the system 100 of FIG. 1, appropriately programmed in accordance with this specification, can perform the process 200.

The system can obtain text data input by a user. In the example of FIG. 2, the text data input by the user includes a deponent statement 202, “I did not speak to Doug in October.”

The system can obtain retrieved relevant documents 210. For example, the retrieved relevant documents 210 can include the relevant documents 152 described above with reference to FIG. 1. The retrieved relevant documents 210 can include documents that are relevant to the deponent statement 202. In the example of FIG. 2, the retrieved relevant documents 210 includes documents 210a-1.

The system can output documents 280 that conflict with the deponent statement 202 by providing the retrieved relevant documents 210 to one or more LLMs. In some implementations, the system can parallelize the processing of the retrieved relevant documents 210. For example, the system can parallelize the processing of the retrieved relevant documents 210 by batching the documents 210. In the example of FIG. 2, the system can batch the 12 documents 210a-2101 into four batches 222, 224, 226, and 228. As an example, batch 222 can include documents 210a-210c, batch 224 can include documents 210d-210f, batch 226 can include documents 210g-i, and batch 228 can include documents 210j-1.

In the example of FIG. 2, the system includes four LLM instances 270a-d. Each LLM instance 270 can be an example of the machine learning model 165 of FIG. 1. Each LLM instance 270 can identify documents 280 that conflict with the deponent statement 202, e.g., in response to a prompt 240. In some examples, the LLM instances 270a-d can have been further trained or fine-tuned, for example, through instruction finetuning, to generate outputs that are responsive to the request of the natural language query.

For example, the system can provide a prompt 240a to LLM instance 270a. The prompt 240a includes the batch 222, the deponent statement 202, and a natural language query. In the example of FIG. 2, the natural language query includes “Identify the discrepancies between the deponent statement and one or more of the documents in the batch, if there are any.”

In some examples, the natural language query can also include a scale of contradiction or level of discrepancy. For example, the natural language query can include “Identify discrepancies that are lies between the deponent statement and one or more of the documents in the batch, if there are any.” As another example, the natural language query can include “Identify discrepancies that represent withholding by the deponent between the deponent statement and one or more of the documents in the batch, if there are any.” As another example, the natural language query can include “Identify discrepancies and the level of discrepancy between the deponent statement and one or more of the documents in the batch, if there are any.”

In some examples, the natural language query can also include a scale of confidence or certainty. For example, the natural language query can include “Identify discrepancies that are over a certainty threshold of ⅗ between the deponent statement and one or more of the documents in the batch, if there are any.”

In some examples, the natural language query can also include a request to explain why the documents and/or statements contradict the deponent statement 202.

In some examples, the prompt 240a can also include user-inputted context that defines a context for the deponent statement 202. For example, the context can include a speaker or author of the documents or a time period. As an example, the context can include the identity of the deponent. In the example of FIG. 2, the user-inputted context can include “This is a statement by Brian,” or “Look for statements made on or after October 1 of this year.”

In the example of FIG. 2, the prompt 240b includes the batch 224, the deponent statement 202, a natural language query, and in some examples, user-inputted context. The prompt 240c includes the batch 226, the deponent statement 202, a natural language query, and in some examples, user-inputted context. The prompt 240d includes the batch 228, the deponent statement 202, a natural language query, and in some examples, user-inputted context.

The system provides data representing the documents 280 identified by the LLM instances 270. For example, in the example of FIG. 2, the LLM instance 270a may identify document 210c as conflicting with the deponent statement 202. The system can provide data representing a statement from the identified document 210c that conflicts with the deponent statement 202, i.e., “I discussed the details with Doug at the reception last night” conflicts with the deponent statement “I did not speak to Doug in October.”

The system can also provide a natural language summary of the documents 280 and/or the contradiction. For example, the summary includes “The statement suggests that the deponent had not spoken to Mr. Nixon in October. Document 12412 proves otherwise.” The document identifier “Document 12412” can be the file name or provided identifier for the document 210c, for example. The system can generate the summary using an LLM such as the LLM instances 270, for example.

In some examples, the system may generate different numbers of batches, e.g., 2, 5, 10, or more batches. In some examples, the system may include different numbers of LLM instances 270, e.g., 1, 5, 10, or more LLM instances 270. In some examples, the system may generate one batch per LLM instance 270. In some examples, the system may include different numbers of documents from the documents 210 in each batch. For example, the system may include more than 1, more than 5, or more than 10 documents in each batch.

FIG. 3 is a flow chart of an example process for performing fact checking. For convenience, the process 300 will be described as being performed by a system of one or more computers located in one or more locations. For example, a system for performing fact checking, e.g., the system 100 of FIG. 1, appropriately programmed in accordance with this specification, can perform the process 300.

The system can receive a trigger (step 310). For example, the system can receive the trigger from a user. The trigger can represent an input from the user that indicates the user would like to perform fact checking for text data. The trigger can also represent an input from the user that indicates the user would like to perform fact checking on text data that has recently been spoken, as described below with reference to step 320.

Responsive to the trigger, the system can obtain text data representing one or more subwords to be processed (step 320). For example, the system can provide an input text box that allows the user to input text data. The system can obtain the text data from the input text box in response to the receipt of the trigger that indicates the user would like to perform fact checking for the text data in the input text box.

For example, the one or more subwords can be part of a statement made by a deponent during a deposition. In some examples, the one or more subwords can also represent a context for the statement. For example, the context can identify a speaker of the statement.

In some implementations, the system can obtain the text data from a transcript of speech. For example, the system can obtain one or more sentences from the transcript of speech. The system can obtain the one or more sentences from the transcript of speech based on user input, for example.

In some implementations, the system can generate the transcript of speech. For example, the system can receive speech data and generate the transcript using a speech-to-text program. In some implementations, the system can include metadata such as timestamps or identity of the speaker in the transcript.

In some implementations, the system can obtain the text data from a sequence of text in response to the receipt of the trigger from the user. The system can use the input processing engine 120 of FIG. 1 to obtain the text data from the sequence of text. For example, the sequence of text can include a transcript of speech that is continuously updated in a live deposition.

The system can obtain multiple sentences from the sequence of text. Each sentence can be associated with metadata such as a timestamp, e.g., a timestamp for the beginning of the sentence, speaker identity, etc. For example, the system can use a tokenizer to divide the sequence of text into sentences. The system can assign a set of one or more sentences from the multiple sentences as the text data to be processed. For example, the set of one or more sentences can have a timestamp that is prior to the time that the trigger from the user was received. For example, the set of one or more sentences can include sentences that were spoken immediately prior to the receipt of the timestamp. The set of one or more sentences can include sentences that were spoken by one speaker. The set of one or more sentences can also include sentences that were spoken by multiple speakers, for example, the set can include a question from one speaker and the answer from another speaker.

As another example, the system can obtain multiple segments from the sequence of text. Each segment can include multiple subwords that are semantically relevant to each other. Each segment can be associated with metadata such as a timestamp, e.g., a timestamp for the beginning of the segment, speaker identity, etc. The system can assign a particular segment from the multiple segments as the text data to be processed. For example, the particular segment can have a timestamp that is prior to the time that the trigger from the user was received. For example, the particular segment can include speech from immediately prior to the receipt of the timestamp. The particular segment can include speech by one speaker. The particular segment can also include speech by multiple speakers, for example, the particular segment can include a question from one speaker and the answer from another speaker.

The system can obtain data representing clusters (step 330). Each cluster can include one or more documents of the multiple documents. Each cluster can be associated with a summary for the cluster. The system can obtain data representing clusters from the document database 103 described above with reference to FIG. 1, for example.

In some implementations, the system can generate the data representing the clusters. For example, the system can obtain document data representing one or more documents. The system can obtain the document data from the user, for example. The system can generate a respective document embedding for each of the one or more documents. The system can use an embedding model, for example, to generate the respective document embeddings. The system can also use the embedding engine 130 described above with reference to FIG. 1. The system can cluster the respective document embeddings for the one or more documents into multiple clusters. For example, the system can use hierarchical agglomerative clustering or nearest neighbor clustering. In some implementations, the number of clusters can be obtained from the user. For example, the system can use nearest neighbor clustering to cluster the document embeddings into n clusters. The system can receive an input from the user identifying the number of clusters n.

For each of the multiple clusters, the system can generate the associated summary for the cluster. For example, for each cluster, the system can provide the documents for the cluster to a machine learning model that is configured to generate a summary for input documents. The summary can include one or more facts found in the input documents. For example, the machine learning model can be an LLM. The system can provide a prompt to the LLM. The prompt can include the documents for the cluster and a query about summarizing the documents. The system can obtain the summary for the cluster from the large language model.

In some implementations, the system can also generate an embedding for each associated summary. In some implementations, the system can also generate an embedding for each document. For example, the system can use an embedding model to generate the embedding for each associated summary and/or each document. The system can also use the embedding engine 130 described above with reference to FIG. 1.

The system can store data representing the documents, embedded documents, clusters, summaries, and/or embedded summaries. For example, the system can store the data in the document database 103 of FIG. 1.

The system can process the text data to identify one or more clusters that are relevant to the text data (step 340). For example, the system can identify one or more clusters as relevant to the text data based on computing a similarity in vector space. The system can use the cluster processing engine 140 of FIG. 1 to identify relevant clusters, for example.

For example, the system can generate an embedded representation for the text data. The system can use the embedding engine 130 of FIG. 1, for example, to generate the embedded representation for the text data. The system can obtain a respective embedding for each summary of each cluster. For example, the system can obtain embedded summaries from the document database 103 of FIG. 1. In some implementations, the system can obtain data representing each summary from the document database 103 and generate a respective embedding for each summary.

For each embedding for each summary, the system can determine a similarity between the embedding and the embedded representation of the text data. Some examples of computing a similarity include cosine similarity, or other functions that receive two vectors and determine a score for the two vectors. As an example, the system can determine a similarity based on the distance in vector space between the embedding and the embedded representation for the text data.

For example, the system can identify a threshold number of clusters as relevant to the text data. For example, the system can determine a similarity to the embedded representation for the text data for each embedding for each summary. The system can identify the top-k clusters that have the highest similarity between the embedding of the summary and the embedded representation of the text data. That is, the top-k clusters can include the clusters whose embeddings for the summaries have the shortest distance to the embedded representation for the text data.

As another example, the system can identify clusters as relevant to the text data that have a distance between the embedding for the summary of the cluster and the embedded representation of the text data that meets a threshold distance. In some implementations, the threshold distance can be a default value. In some implementations, the system can receive the threshold distance from the user.

As another example, the system can determine a similarity using a machine learning model that is configured to generate a similarity score between vectors. For example, the system can provide the embedding and the embedded representation for the text data to the machine learning model.

For each embedding for each summary, the system can determine whether the similarity meets a threshold similarity. In some implementations, the threshold similarity can be a default value. In some implementations, the system can receive the threshold similarity from the user.

If the similarity meets the threshold similarity, the system can identify the cluster for the embedding as relevant to the text data.

In some implementations, the system can exclude certain clusters based on particular criteria. For example, each of the documents can include metadata. The metadata can include attribute values for one or more attributes such as speaker, author, time, etc. The system can filter the clusters based on particular criteria. The particular criteria can define attribute values for the one or more attributes. The system can identify one or more qualifying clusters having documents that include attribute values matching the particular criteria. In some implementations, the particular criteria can be defined by the user.

For example, the particular criteria can indicate the time is within the last month. The system can identify one or more clusters that include documents that include a time that is within the last month. The system can then obtain an embedding for each qualifying cluster of the one or more qualifying clusters and identify whether any of the one or more clusters are relevant to the text data.

For each of the identified clusters, the system can identify one or more documents of the identified cluster that are relevant to the text data (step 350). For example, the system can identify one or more documents as relevant to the text data based on computing a similarity in vector space. The system can use the document processing engine 150 to identify relevant documents, for example.

For each document of the identified cluster, the system can determine a document similarity between an embedded representation of the document and an embedded representation of the text data. For example, the system can generate an embedded representation for the text data. The system can use the embedding engine 130 of FIG. 1, for example, to generate the embedded representation for the text data. The system can obtain an embedded representation of the document from the document database 103 of FIG. 1. In some implementations, the system can obtain data representing the document from the document database 103 and generate an embedded representation using the embedding engine 130 of FIG. 1.

Some examples of computing a similarity include, as described above, cosine similarity, or other functions that receive two vectors and determine a score for the two vectors. As an example, the system can determine a similarity based on the distance in vector space between the embedded representation of the document and the embedded representation for the text data.

For example, the system can identify a threshold number of documents as relevant to the text data. For example, the system can determine a similarity to the embedded representation for the text data for the embedded representation of each document. The system can identify the top-k documents that have the highest similarity between the embedded representation of the document and the embedded representation of the text data. That is, the top-k documents can include the documents whose embedded representations have the shortest distance to the embedded representation for the text data.

As another example, the system can identify documents as relevant to the text data that have a distance between the embedded representation for the document and the embedded representation of the text data that meets a threshold distance. In some implementations, the threshold distance can be a default value. In some implementations, the system can receive the threshold distance from the user.

As another example, the system can determine a similarity using a machine learning model that is configured to generate a similarity score between vectors. For example, the system can provide the embedded representation of the document and the embedded representation for the text data to the machine learning model.

For each document of the identified cluster, the system can determine whether the document similarity meets a document threshold similarity. In some implementations, the document threshold similarity can be a default value. In some implementations, the system can receive the document threshold similarity from the user.

If the document similarity meets the document threshold similarity, the system can identify the document as relevant to the text data.

For each of the identified clusters, the system can identify one or more documents that contradict the text data of the identified documents that are relevant to the text data (step 360). The system can use the document contradiction engine 160 to identify contradictory documents, for example.

For example, the system can use one or more language models such as the LLM instances 270 described with reference to FIG. 2. The system can provide an input prompt that includes at least the text data and one or more documents from the identified documents to a language model. The language model can generate an output that indicates whether the text data contradicts the document(s) of the input prompt. The system can identify the document(s) of the input prompt as contradicting the text data based on the output.

The input prompt can also include a query such as whether the document(s) include statements that contradict the text data, how many statements in the document(s) contradict the text data, “identify statements in the document that contradict the statement,” “identify statements in the documents that contradict the statement,” “identify the discrepancies if there are any,” and other natural language queries about contradictions in the document(s).

In some examples, the input prompt can include context. For example, the context can identify a particular speaker or author, or a time period. In some implementations, the context can be defined by the user. The input prompt can also include document identifiers or document names for each of the documents in the input prompt.

The language model can generate an output that answers the query. The system can identify one or more of the document(s) of the input prompt as contradicting the text data based on the output.

For example, the input prompt can include a query such as whether the document includes statements that contradict the text data. The output may be an affirmative or a negative answer for whether the document includes statements that contradict the text data. If the output is an affirmative answer, the system can identify the document of the input prompt as contradicting the text data. In some examples where the input prompt includes multiple documents, the input prompt can include a query such as which documents include statements that contradict the text data. The output may be a list of document identifiers for which documents include statements that contradict the text data, or a negative answer. If the output is a list of document identifiers, the system can identify the documents of the document identifiers as contradicting the text data.

As another example, if the query includes how many statements in the document contradict the text data, the output may include a zero or nonzero number. If the output includes a nonzero number, the system can identify the document of the input prompt as contradicting the text data. In some examples where the input prompt includes multiple documents, the input prompt can include a query such as how many statements in each document contradict the text data. The output may include a zero or nonzero number for each document. If the output includes a nonzero number for one or more documents, the system can identify the documents that have a nonzero number as contradicting the text data.

As another example, if the query includes “identify statements in the document that contradict the statement” or “identify the discrepancies if there are any,” the output may include statements or subwords of the document that contradict the text data or a negative answer. If the output includes statements or subwords of the document, the system can identify the document of the input prompt as contradicting the text data. In examples where the prompt includes multiple documents, if the query includes “identify statements in the documents that contradict the statement” or “identify the discrepancies if there are any,” the output may include statements or subwords of one or more documents that contradict the text data or a negative answer. If the output includes statements or subwords of one or more documents, the system can identify the one or more documents as contradicting the text data.

In some examples, the system can provide multiple input prompts that each have different queries for the same document or documents and text data. The system can identify documents that contradict the text data based on combining the outputs for each of the multiple input prompts.

In some implementations, the system can identify documents that meet a threshold contradiction score as documents that contradict the text data. For example, the system can determine a contradiction score between each document and the text data using a machine learning model. For example, the contradiction score can represent a likelihood that two sequences of text negate each other. For each document of the identified documents, the system can provide the document and the text data to a machine learning model. The machine learning model can be configured to generate a contradiction score representing a likelihood that two input sequences of text negate each other.

For example, the machine learning model can be a large language model. For example, the system can provide a prompt to the large language model that includes a query with a request to identify discrepancies on a scale of contradiction. For example, the scale of contradiction can be a scale of 1 to 5, with 1 being the least contradictory and 5 being the most contradictory.

For each document of the identified documents, the system can determine whether the contradiction score meets a threshold contradiction score. In some implementations, the threshold contradiction score can be a default value. In some implementations, the system can receive the threshold contradiction score from the user.

If the contradiction score meets the threshold contradiction score, the system can identify the document as contradicting the text data.

The system can provide data representing the one or more identified documents that contradict the text data (step 370). For example, the system can provide data representing the identified documents that contradict the text data to a user through a user interface.

In some implementations, the system can also provide data representing one or more statements that contradict the text data of the identified documents that contradict the text data or of the identified documents that are relevant to the text data. For example, for each of the one or more identified documents that contradict the text data or the one or more identified documents that are relevant to the text data, the system can identify one or more statements of the identified document that contradict the text data. The system can provide data representing the identified statements to the user. The system can identify statements that contradict the text data using the statement processing engine 170 of FIG. 1, for example.

In some implementations, for each of the one or more identified documents that contradict the text data, the system can provide an input prompt that includes at least the text data and the identified document to a language model. The language model can generate an output indicating which statements of the identified document contradict the text data. The system can identify one or more statements of the identified document as contradicting the text data based on the output.

In some implementations, for at least one of the one or more identified documents that contradict the text data, the system can provide an input prompt that includes at least the text data and the at least one identified document to a language model. The language model can generate an output indicating which statements of the at least one identified document contradict the text data. The system can identify one or more statements of the at least one identified document as contradicting the text data based on the output.

The input prompt can also include a query such as “identify statements in the document that contradict the statement,” “identify the discrepancies if there are any,” and other natural language queries about contradicting statements in the document.

In some examples, the input prompt can include context. For example, the context can identify a particular speaker or author, or a time period. In some implementations, the context can be defined by the user. The language model can generate an output that answers the query. The system can identify the document of the input prompt as contradicting the text data based on the output. For example, if the query includes “identify statements in the document that contradict the statement” or “identify the discrepancies if there are any,” the output may include statements or subwords of the document that contradict the text data or a negative answer. If the output includes statements or subwords of the document, the system can identify the statements or subwords as contradicting the text data.

In some examples, the input prompt can include more than one document. In these examples, the system can identify one or more statements of the documents of the input prompt as contradicting the text data based on the output. For example, the input prompt can include a query such as “identify statements in the documents that contradict the statement,” “identify the discrepancies if there are any,” and other natural language queries about contradicting statements in the document. The input prompt can also include document identifiers or document names for each of the documents in the input prompt. If the query includes “identify statements in the documents that contradict the text data” or “identify the discrepancies if there are any,” the output may include statements or subwords of one or more documents that contradict the text data or a negative answer. If the output includes statements or subwords of one or more documents, the system can identify the statements as contradicting the text data.

In some implementations, the system can identify statements that meet a threshold contradiction score as statements that contradict the text data. For example, the system can determine a contradiction score between each statement and the text data using a machine learning model. For example, the contradiction score can represent a likelihood that two sequences of text negate each other. For each statement of each identified document, the system can provide the statement and the text data to a machine learning model. The machine learning model can be configured to generate a contradiction score representing a likelihood that two input sequences of text negate each other.

For example, the machine learning model can be a large language model. For example, the system can provide a prompt to the large language model that includes a query with a request to identify discrepancies on a scale of contradiction. For example, the scale of contradiction can be a scale of 1 to 5, with 1 being the least contradictory and 5 being the most contradictory.

For each statement of the identified statements, the system can determine whether the contradiction score meets a threshold contradiction score. In some implementations, the threshold contradiction score can be a default value. In some implementations, the system can receive the threshold contradiction score from the user.

If the contradiction score meets the threshold contradiction score, the system can identify the statement as contradicting the text data.

In some examples, the query can include a request to generate explanations for why the document(s) and/or statement(s) contradict the text data. The output from the large language model may include document(s) and/or statement(s) from the document(s) that contradict the text data, and explanations for why the document(s) and/or statement(s) contradict the text data. The system can identify the document(s) and/or statement(s) as contradicting the text data.

In some examples, the system can also provide data representing explanations for the one or more identified documents or the one or more identified statements to the user. For example, the system can provide an input prompt to the large language model that includes a query with a request to identify discrepancies and to generate explanations for the discrepancies. The data representing explanations can include citations from the documents and/or reasoning that explains the discrepancies.

In some examples, the query can also include a request to identify a level or degree of discrepancy for document(s) and/or statement(s) that contradict the text data. For example, the input prompt can include a quantitative scale of contradiction, such as 1 to 5. As an example, the query can include “identify the discrepancies if there are any, and rate them on a scale of contradiction from 1 to 5.” The output from the large language model may include document identifier(s) for document(s) and/or statement(s) that contradict the text data, and a level of discrepancy for each document and/or statement. For example, the output can include a quantitative level of discrepancy or contradiction score, such as 3 on a scale of 1 to 5, for each document and/or statement.

As another example, the level of discrepancy can be described in natural language such as “lie” or “withholding.” As an example, the query can include “identify the discrepancies if there are any, and label them as direct lies or as representative of withholding.” The output from the large language model can include a label for each document and/or statement such as “lie” or “withholding.” The system can identify the document(s) and/or statement(s) as contradicting the text data.

In some examples, the system can also provide data representing a level of discrepancy for the one or more identified documents or the one or more identified statements to the user. For example, the system can provide an input prompt to the large language model that includes a query with a request to identify discrepancies and to identify a level of discrepancy for the discrepancies. The data representing a level of discrepancy can include a number on a scale, or a label such as “lie” or “withholding.”

In some examples, the system can use feedback received from the user for tuning. For example, the system can provide data representing the identified documents and/or the identified statements to the user. The system can also provide a user interface that allows the user to indicate their agreement or their disagreement with the identified documents and/or the identified statements. In some examples, the system can also provide a text box for the user to describe their agreement or disagreement with the outputs of the system. The system can receive the user inputs that indicate agreement or disagreement and use the user inputs for tuning. For example, the system can further train or fine-tune the large language model based on the user inputs, or update the threshold contradiction score to identify documents and/or identified statements that are more likely to align with the feedback.

In some examples, the system may receive a second trigger for performing fact checking on a second sequence of text data while performing the process 300 for a first sequence of text data. The system can perform the process 300 for the second sequence of text data in parallel with the process 300 for the first sequence of text data.

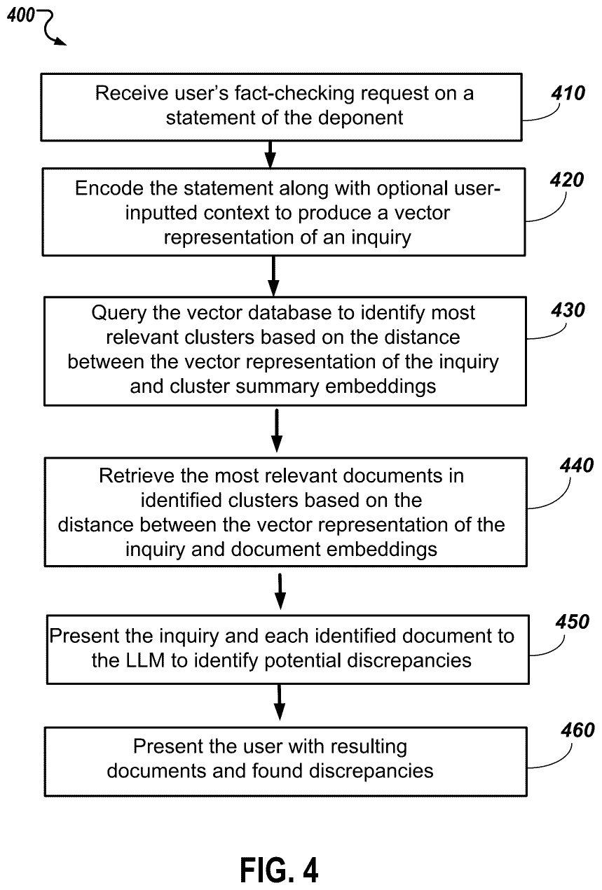

FIG. 4 is a flow chart of another example process for performing fact checking. For convenience, the process 400 will be described as being performed by a system of one or more computers located in one or more locations. For example, a system for performing fact checking, e.g., the system 100 of FIG. 1, appropriately programmed in accordance with this specification, can perform the process 400. The process 400 is an example of the process 300, performed in the context of a live deposition with a deponent that is speaking.

The system receives a user's fact-checking request on a statement of the deponent (step 410). The system can receive the fact-checking request through a user interface such as the example user interface described below with reference to FIG. 5. The fact-checking request can include the trigger and the statement of the deponent. In some examples, the fact-checking request can include user-inputted context.

The system encodes the statement along with optional user-inputted context to produce a vector representation of an inquiry (step 420). The system can use an embedding model or the embedding engine 130 of FIG. 1 to encode, or embed, the statement and/or the user-inputted context. The vector representation of the inquiry can thus include an embedded representation of the statement. In some examples, the vector representation of the inquiry can include an embedded representation of the statement and the user-inputted context.

The system queries the vector database to identify most relevant clusters based on the distance between the vector representation of the inquiry and cluster summary embeddings (step 430). The vector database can be a part of the document database 103 of FIG. 1. The vector database can include cluster summary embeddings, also referred to as embedded cluster summaries. The vector database can include embeddings of summaries of clusters of documents. The documents can have been input, for example, by the user. The documents can include documents produced during discovery such as business records, communication records, etc.

The system can identify the most relevant clusters based on the distance in vector space between the vector representation of the inquiry and the cluster summary embeddings. For example, the system can determine a distance between the vector representation of the inquiry and each cluster summary embedding. The most relevant clusters can be the top-k clusters whose cluster summary embeddings have the shortest distance to the vector representation of the inquiry, or the clusters whose cluster summary embeddings have a distance to the vector representation of the inquiry that meets a threshold distance.

The system retrieves the most relevant documents in identified clusters based on the distance between the vector representation of the inquiry and document embeddings (step 440). The vector database can also include document embeddings, also referred to as embedded documents or embedded representations of documents. For each of the identified clusters that were identified as most relevant, the system can process the documents of the identified cluster to identify the most relevant documents based on the distance in vector space between the vector representation of the inquiry and the document embeddings. For example, the system can determine a distance between the vector representation of the inquiry and each document embedding. The most relevant documents can be the top-k documents for which the embedded documents have the shortest distance to the vector representation of the inquiry, or the documents for which the embedded documents have a distance to the vector representation of the inquiry that meets a threshold distance.

The system presents the inquiry and each identified document to the LLM to identify potential discrepancies (step 450). For example, the system can generate an input prompt that includes the inquiry (the statement of the deponent and, in some examples, user-inputted context) and one or more of the identified documents. The input prompt can also include a query such as “identify potential discrepancies.” The LLM can generate an output that indicates any potential discrepancies between the inquiry and the documents of the input prompt.

The system presents the user with resulting documents and found discrepancies (step 460). For example, the system can present the user with documents and discrepancies through a user interface such as the example user interface described below with reference to FIG. 5. In some implementations, the system can present the user with a summary of the discrepancies, contradicting statements, and/or locations of contradicting statements and documents.

FIG. 5 is an example user interface 500 for interaction with an example system for performing fact checking, such as the system 100 of FIG. 1. The user interface 500 can include multiple user interface components such as a transcript 510, filters 520, a statement input text box 530, a fact check button 540, and a results window 550.

The transcript 510 can display a transcript of speech. For example, the transcript of speech can be a transcript of deposition proceedings. The transcript can be generated by a speech-to-text program. In some examples, the transcript 510 can also display timestamps of speech and/or identifiers for the speaker of the speech.

The filters 520 can allow for a user to provide optional context. For example, the user can provide names such as the name of the deponent, or the name of authors of documents. The user can also provide a time period for the documents of interest.

The statement input text box 530 can allow for a user to provide a statement to be fact checked. For example, the user can provide a statement made by a deponent during the deposition proceeding. For example, the user can type the statement, or copy the statement from the transcript 510 and paste the statement into the statement input text box 530.

In some examples, the user interface 500 can allow for a user to provide a statement to be fact checked directly from the transcript 510. For example, the user interface 500 can include a user interface component that allows the user to highlight the statement to be fact checked while the statement is displayed in the transcript 510.

The fact check button 540 can allow for a user to submit the request for fact checking to the system 100. For example, the request for fact checking can include the information of the filters 520 and the statement input text box 530. In examples where the user interface 500 allows the user to highlight the statement to be fact checked, the request for fact checking can include the information of the filters 520 and the highlighted statement. The request can also indicate the trigger for fact checking. Upon receiving input to the fact check button 540, the system 100 can receive the trigger, the statement, and/or context.

In some examples, the request for fact checking can include the information of the filters 520 and the transcript 510. The request can also indicate the trigger for fact checking. Upon receiving input to the fact check button 540, the system 100 can receive the trigger, the transcript data, and/or context. The system 100 can use the timing of the trigger and the timing of the transcript data to determine the statement to be processed.

The results window 550 can display data representing identified documents and/or identified statements. For example, the results window 550 can display document names or identifiers, or the content of the documents. The results window 550 can also display identified statements as highlighted within the content of the document. The results window 550 can also display summaries of the contradictions generated by the system 100.

In some implementations, the user interface 500 can include user interface components that allow for a user to input documents to be processed by the system 100. For example, the user interface 500 can include user interface components for selecting and uploading files.

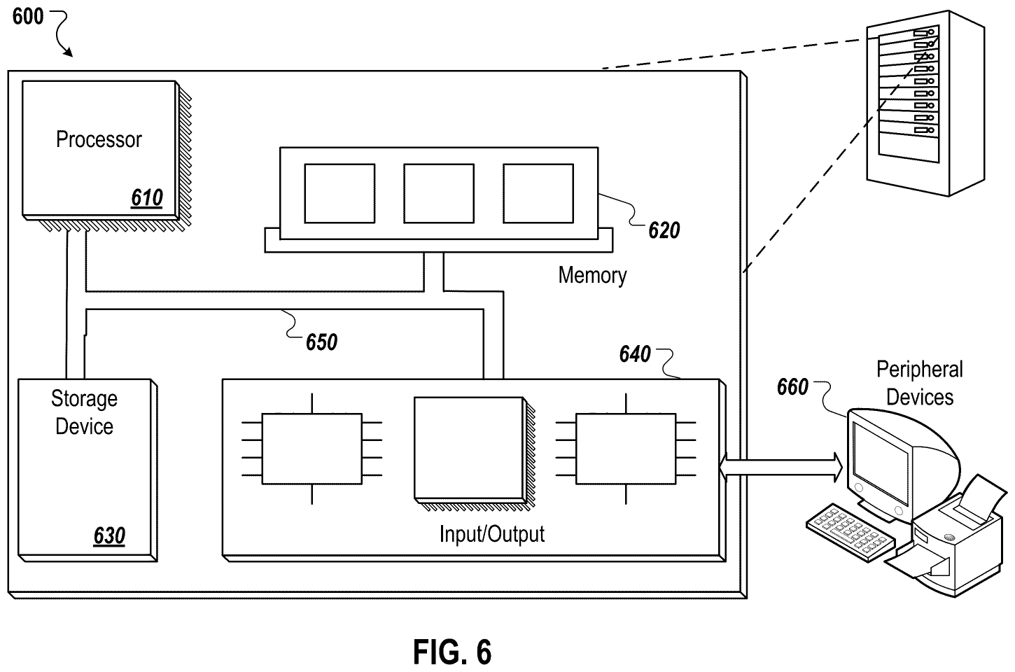

FIG. 6 depicts a schematic diagram of a computer system 600. The system 600 can be used to carry out the operations described in association with any of the computer-implemented methods described previously, according to some implementations. In some implementations, computing systems and devices and the functional operations described in this specification can be implemented in digital electronic circuitry, in tangibly-embodied computer software or firmware, in computer hardware, including the structures disclosed in this specification (e.g., system 600) and their structural equivalents, or in combinations of one or more of them. The system 600 is intended to include various forms of digital computers, such as laptops, desktops, workstations, personal digital assistants, servers, blade servers, mainframes, and other appropriate computers, including vehicles installed on base units or pod units of modular vehicles. The system 600 can also include mobile devices, such as personal digital assistants, cellular telephones, smartphones, and other similar computing devices. Additionally, the system can include portable storage media, such as, Universal Serial Bus (USB) flash drives. For example, the USB flash drives may store operating systems and other applications. The USB flash drives can include input/output components, such as a wireless transducer or USB connector that may be inserted into a USB port of another computing device.

The system 600 includes a processor 610, a memory 620, a storage device 630, and an input/output device 640. Each of the components 610, 620, 630, and 640 are interconnected using a system bus 650. The processor 610 is capable of processing instructions for execution within the system 600. The processor may be designed using any of a number of architectures. For example, the processor 610 may be a CISC (Complex Instruction Set Computers) processor, a RISC (Reduced Instruction Set Computer) processor, or a MISC (Minimal Instruction Set Computer) processor.

In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output device 640.

The memory 620 stores information within the system 600. In one implementation, the memory 620 is a computer-readable medium. In one implementation, the memory 620 is a volatile memory unit. In another implementation, the memory 620 is a non-volatile memory unit.

The storage device 630 is capable of providing mass storage for the system 600. In one implementation, the storage device 630 is a computer-readable medium. In various different implementations, the storage device 630 may be a floppy disk device, a hard disk device, an optical disk device, or a tape device.

The input/output device 640 provides input/output operations for the system 600. In one implementation, the input/output device 640 includes a keyboard and/or pointing device. In another implementation, the input/output device 640 includes a display unit for displaying graphical user interfaces.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a key vectorboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method comprising:
receiving a trigger from a user;
responsive to the trigger, obtaining text data representing one or more subwords to be processed;
obtaining data representing a plurality of clusters, wherein each cluster comprises one or more documents of a plurality of documents;
processing the text data to identify one or more clusters of the plurality of clusters that are relevant to the text data;
for each of the one or more identified clusters:
identifying one or more documents of the identified cluster that are relevant to the text data;
identifying one or more documents that contradict the text data of the one or more identified documents that are relevant to the text data; and
providing data representing the one or more identified documents that contradict the text data.

2. The method of claim 1, further comprising:
identifying one or more statements that contradict the text data of the one or more identified documents that contradict the text data; and
providing data representing the one or more identified statements to the user.

3. The method of claim 1, wherein obtaining text data comprises obtaining the text data from a transcript of speech.

4. The method of claim 1, wherein obtaining text data comprises:
obtaining a plurality of sentences from a sequence of text, wherein each sentence is associated with a timestamp; and
assigning a set of one or more sentences from the plurality of sentences as the text data, wherein each sentence in the set of one or more sentences is associated with a timestamp prior to a time that the trigger from the user was received.

5. The method of claim 1, wherein obtaining text data comprises:
obtaining a plurality of segments from a sequence of text, wherein each segment comprises a plurality of subwords that are semantically relevant, and wherein each segment is associated with a timestamp; and
assigning a particular segment from the plurality of segments as the text data, wherein the particular segment is associated with a timestamp prior to a time that the trigger from the user was received.

6. The method of claim 1, wherein each cluster is associated with a summary for the cluster, and wherein obtaining data representing a plurality of clusters comprises generating the data representing the plurality of clusters, and wherein generating the data representing the plurality of clusters comprises:
obtaining document data representing one or more documents;
generating a respective document embedding for each of the one or more documents;
clustering the respective document embeddings for the one or more documents into a plurality of clusters; and
for each of the plurality of clusters, generating the associated summary for the cluster.

7. The method of claim 6, wherein clustering the respective document embeddings comprises clustering using hierarchical agglomerative clustering.

8. The method of claim 6, wherein clustering the respective document embeddings comprises clustering using nearest neighbor clustering.

9. The method of claim 6, wherein generating the associated summary for the cluster comprises providing the documents for the cluster to a machine learning model that is configured to generate a summary for input documents, wherein the summary comprises one or more facts in the input documents.

10. The method of claim 1, wherein each cluster is associated with a summary for the cluster, and wherein processing the text data to identify one or more clusters of the plurality of clusters that are relevant to the text data comprises:
generating an embedded representation for the text data;
obtaining a respective embedding for each summary of each cluster;
for each respective embedding for each summary:
determining a similarity between the respective embedding and the embedded representation for the text data;
determining that the similarity meets a threshold similarity; and
in response, identifying the cluster for the respective embedding as relevant to the text data.

11. The method of claim 10, wherein each of the documents of the plurality of documents includes metadata, and wherein the metadata comprises attribute values for one or more attributes, and wherein obtaining a respective embedding for each summary of each cluster comprises:
filtering the plurality of clusters to identify one or more qualifying clusters having documents that include attribute values matching particular criteria, wherein the particular criteria defines one or more attribute values for the one or more attributes; and
obtaining a respective embedding for each summary of each qualifying cluster of the one or more qualifying clusters.

12. The method of claim 11, wherein the particular criteria is defined by the user.

13. The method of claim 1, wherein identifying one or more documents of the identified cluster that are relevant to the text data comprises:
for each document of the identified cluster:
determining a document similarity between an embedded representation of the document and an embedded representation of the text data;
determining that the document similarity meets a document threshold similarity; and
in response, identifying the document as relevant to the text data.

14. The method of claim 1, wherein identifying one or more documents that contradict the text data of the one or more identified documents that are relevant to the text data comprises:
for each document of the identified documents that are relevant to the text data:
determining a contradiction score between the document and the text data using a machine learning model;
determining that the contradiction score meets a threshold contradiction score; and
in response, identifying the document as contradicting the text data.

15. The method of claim 14, wherein the machine learning model is a large language model.

16. The method of claim 14, wherein the machine learning model is configured to generate a contradiction score representing a likelihood that two input sequences of text negate each other.

17. The method of claim 1, wherein identifying one or more documents that contradict the text data of the one or more identified documents that are relevant to the text data comprises:
providing an input prompt comprising at least the text data and one or more documents of the identified documents that are relevant to the text data to a language model to generate an output indicating whether the text data contradicts the one or more documents of the input prompt; and
identifying one or more documents of the input prompt as contradicting the text data based on the output.

18. The method of claim 2, wherein identifying one or more statements that contradict the text data of the one or more identified documents that contradict the text data comprises:
providing an input prompt comprising at least the text data and the one or more identified documents to a language model to generate an output indicating which statements of the one or more identified documents contradict the text data; and
identifying one or more statements of the one or more identified documents as contradicting the text data based on the output.

19. A system comprising:
one or more computers; and
one or more storage devices storing instructions that, when executed by the one or more computers, cause the one or more computers to perform operations comprising:
receiving a trigger from a user;
responsive to the trigger, obtaining text data representing one or more subwords to be processed;
obtaining data representing a plurality of clusters, wherein each cluster comprises one or more documents of a plurality of documents;
processing the text data to identify one or more clusters of the plurality of clusters that are relevant to the text data;
for each of the one or more identified clusters:
identifying one or more documents of the identified cluster that are relevant to the text data;
identifying one or more documents that contradict the text data of the one or more identified documents that are relevant to the text data; and
providing data representing the one or more identified documents that contradict the text data.

20. One or more computer-readable storage media storing instructions that when executed by one or more computers cause the one or more computers to perform operations comprising:
receiving a trigger from a user;
responsive to the trigger, obtaining text data representing one or more subwords to be processed;
obtaining data representing a plurality of clusters, wherein each cluster comprises one or more documents of a plurality of documents;
processing the text data to identify one or more clusters of the plurality of clusters that are relevant to the text data;
for each of the one or more identified clusters:
identifying one or more documents of the identified cluster that are relevant to the text data;
identifying one or more documents that contradict the text data of the one or more identified documents that are relevant to the text data; and
providing data representing the one or more identified documents that contradict the text data.
